(19) United States
(12) Patent Application Publication
(10) Pub. No.: US 2005/0225292 A1
(43) Pub. Date: Oct. 13, 2005

(54) Charger and recharger device

(76) Inventors: Jean-Jacques Damlamian, City Clamart (FR); Didier Marquet, Malakoff (FR)

Correspondence Address: ROTHWELL, FIGG, ERNST & MANBECK, P.C., 1425 K STREET, N.W., SUITE 800, WASHINGTON, DC, 20005, US

(21) Appl. No.: 10/519,870

(22) PCT Filed: Jun. 27, 2003
(86) PCT No.: PCT/FR03/01995

§ 371 Date: May 3, 2005

(30) Foreign Application Priority Data
Jul. 1, 2002 (FR) 02/08192

(51) Int. Cl. H02J 7/02

(52) U.S. Cl. 320/128

(57) ABSTRACT

The invention concerns a portable charger (10) comprising a connection to an electric source, a plurality of connecting points (14a, 14b,) of rechargeable portable appliances for different usage, and an adapter (16), tapping power supply at the electric source and adapting it to the recharging supply of the rechargeable portable appliances, the adapter (16) including a microprocessor (22) and a multiple output converter delivering voltages and currents adapted to the appliances to be recharged, the adapter adapting the charge power to the portable appliance based on the charge programme delivered by the charger. The invention also concerns a recharge device comprising the portable charger. The invention enables simultaneous recharge of different rechargeable appliances in a manner adapted to each appliance. Thus the user of several rechargeable appliances needs only one charger.

### BACKGROUND OF THE INVENTION

The present invention relates to a charger and charging system,

Numerous portable battery powered devices currently exist. They can operate without au electricity supply thanks to an internal rechargeable battery. Examples are cellphones, PDAs (Personal Digital Assistant), laptop computers, and so on. In the case of mobile phones, to be able to call hands-free, telephones can be fitted with an earpiece incorporating a microphone and loudspeaker. They allow conversation without the cellphone being required to be held close to the ear and mouth.

In use, as they are portable, these devices do not have any wire connection. Information is transmitted between the various devices for example via a wireless link of the Bluetooth™ type.

One disadvantage of such items of equipment is their limited reserve time—the time they can operate without recharging—due to the capacity of their battery or accumulator to store energy. Consequently, the user of such devices must regularly remember to recharge them with a charger connected to the electrical supply.

Each item of portable electrical equipment is currently designed with its own charger allowing it to be connected to the utility electrical supply. Such chargers are each compatible with their specific item of equipment.

Chargers are consequently specific both as regards their shape as well as their means of connection and type of connection. It will be readily understood that the charger for a PDA is not designed like the charger for a telephone earpiece in view of the differences in connection and electrical power of the two items of equipment to be recharged.

Consequently, this multiplies the number of chargers for such portable electrical equipment. The multiplicity of such charging equipment increases cost in particular for the user who is required to buy one when he purchases each item of equipment. The multiplicity of the these items of charging equipment also takes up space which is particularly inconvenient for the user who is travelling.

The Targus company is selling a product known as the Targus Universal Auto/Air Notebook Power Adapter allowing different types of rechargeable mobile equipment to be recharged. This equipment checks the corresponding voltage depending on the requirements of the mobile equipment, and adapts recharging as a consequence.

The disadvantage of this equipment is that the user may forget to recharge one of these items of portable equipment and find it not available for use through lack of power at the time of use.

### SUMMARY OF THE INVENTION

There is consequently a need for users to have available recharging equipment which can reduce the risk of forgetting to recharge an item of portable equipment.

To solve this problem, the invention provides a portable charger comprising
a connection to a source of electrical power, a plurality of connection points for items of portable rechargeable equipment for different uses, and an adapter being powered by said source of electrical power and adapting it to provide recharging power for the items of portable rechargeable equipments.

Preferably, the adapter comprises a microprocessor and a multi-voltage converter.

Preferably, the adapter supplies voltages and currents adapted to said items of equipment to be recharged.

Preferably, the connection point(s) are of the RJ 45 type: alternatively, they can be of woven ribbon.

There is also provided a recharging device comprising the above charger and a plurality of items of portable rechargeable equipment for different uses connected to said charger.

Preferably, the charger can be connected by a suitable lead to a vehicle cigarette lighter or adapted to a utility mains supply.

In one embodiment, a connection point of said charger is a woven ribbon co-operating with another differently woven ribbon on one of said items of portable equipment, the said ribbons gripping each other by contact. The ribbons can comprise conducing fibers for the recharging power supply.

In one embodiment, the items of portable equipment are fastened by magnetization on said charger.

In one embodiment, the items of portable equipment and said charger each have a magnet with North-South polarity. Alternatively, the items of portable equipment can comprise a soft iron pole piece co-operating with a magnet on the charger, or vice versa.

In one embodiment, a first item of equipment can be connected to a second item of equipment, the first item of equipment connecting the second item of equipment to the charger.

The device can further comprise a computer connected to said charger, the adapter adapting charging power to the item of portable equipment as a function of a charging program supplied by said computer.

The items of equipment are preferably of the type that include at least one rechargeable battery.

Further characteristics and advantages of the invention will become more clear from the detailed description that follows of some embodiments of the invention provided solely by way of example and with reference to the attached drawings.

### BRIEF DESCRIPTION OF THE DRAWINGS

FIG. 1 shows a battery charger according to one embodiment of the invention.

FIG. 2 shows recharging equipment that comprises the charger of FIG. 1.

FIGS. 3-5 show one example of connection between items of portable equipment.

FIG. 6 shows one example of detection of connection on the charger of an item of equipment to be recharged.

### DETAILED DESCRIPTION OF PREFERRED EMBODIMENTS

The invention provides a portable charger on which a plurality of rechargeable portable items of equipment for different uses can be connected. The charger adapts the recharge power supply to each item of equipment. The invention makes it possible to recharge various items of rechargeable equipment simultaneously, appropriate to each item of equipment. The risk of the user forgetting to recharge an item of rechargeable equipment is reduced. Further, the invention avoids the user having to cope with successively recharging different items of portable equipment; the user can consequently simultaneously recharge various items of equipment during the night without having to connect each one in turn to the charger.

By the expression “charging” or “recharging”, we also mean the operation of powering portable equipment.

Rechargeable portable equipment should be taken to mean equipment that operates with a battery or accumulator capable of being recharged. The battery or accumulator may or may not be separable from the equipment. The equipment can be carried around with the person. By “different uses” we mean equipment intended for different purposes; for example, a laptop computer, a mobile phone, a PDA are such items of equipment intended for different uses.

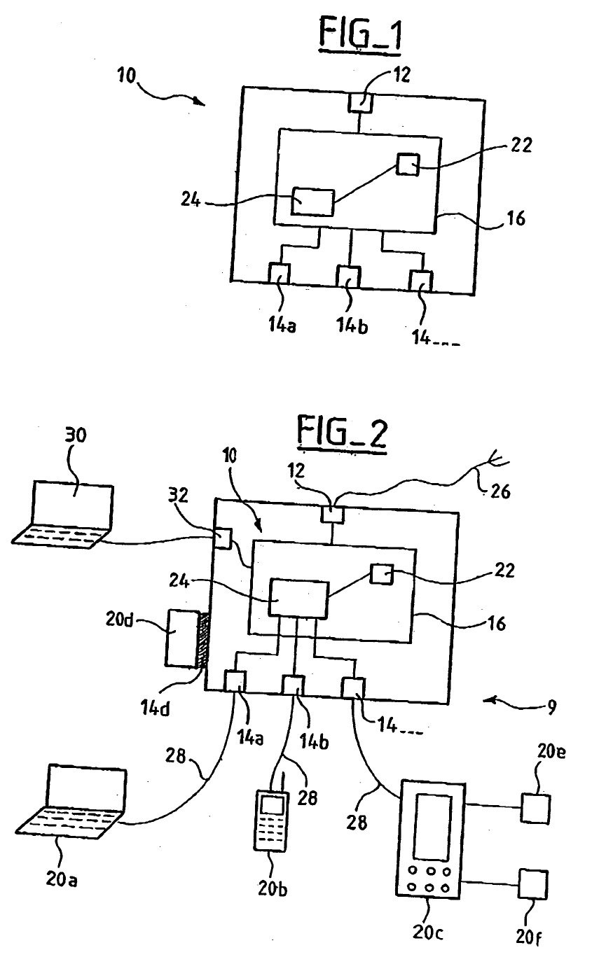

FIG. 1 shows a charger 10. Portable charger 10 comprises a connection 12 to a source of electrical power. Charger 10 also comprises a plurality of connection points 14a, 14b, and so on for rechargeable items of portable equipment for different uses. The number of connection points can vary as a function of the size of the charger; the charger comprises at least two connection points, each designed for connection to an item of equipment. Charger 10 further comprises an adapter 16 which takes power from the electrical source and adapts it to the recharge power requirements for the items of rechargeable equipment.

Charger 10 is a voltage converter supplying low voltage rectified DC current or battery charging. Advantageously, charger 10 is a portable charger, designed to be carried around with the person. The size of the charger depends on the number of connection points. The advantage is that the user only needs to take charger 10 with him when travelling so as to be able to charge all items of portable rechargeable equipment.

Connection 12 allows the charger to be powered for recharging the items of equipment 20a, 20b, and so on. Connection 12 allows charger 10 to be connected to the utility supply for example 230 volt supply or to a 12 volt vehicle cigarette lighter. As charger. 10 is portable, the user can recharge his portable equipment in his car while travelling. A further advantage of having just one charger 10 is that in only occupies one socket outlet for receiving power instead of each item of equipment requiring a separate socket outlet, or the user employing a multiple adapter. Further, as socket outlets differ from one country to the other, the user would need a special adapter when travelling abroad. Thus, another advantage of having one single charger 10 is that when abroad, the user does not require an adapter to recharge each one of his items of portable equipment.

The points of connection 14a, 14b, and so on allow a plurality of items of portable equipment to be connected and recharged, independently of their shape and without separating the bat from the portable equipment. The advantage is that the items of equipment do not require to be plugged into charger 10, thereby reducing the latter's size. The connection points 14a, 14b and so on can be of different types. For example, a connection point of the RJ 45 type, a so-called universal connection point is becoming more and more common on communications equipment. RJ 45 connection points make it possible to provide detection of the program for charging equipment 20a, 20b etc thanks to the use of locating key means ensuring correct insertion. The items of portable equipment can use connection plugs different from the RJ 45 connection point. Different connection plugs for the same RJ 45 connection point are available for the portable equipment. For example, a laptop computer will use plugs that are different from a cellphone which will allow charger 10 to detect what type of equipment is connected. The RJ 45 type connection points can include built-in structural key means ensuring correct connection and recognition of the type of charge.

According to one embodiments, the connection points 14a, 14b etc. can be magnets or woven ribbon. The nature of the connection points will be discussed in more detail below.

Adapter 16 allows charger 10 to be compatible with items of rechargeable equipment adapted for differing charging programs. For example, adapter 16 with charger 10 allows a laptop computer having 3A charge current and a charging voltage of 19V to be charged just like a cellphone accepting a 700 mA charge current and 5V charging voltage. Adapter 16 typically includes a microprocessor 22 and a multi-voltage converter 24.

Multi-voltage converter 24 provides for converting the power supply to the charger from the electrical source. Multi-voltage converter 24 produces a plurality of low-voltage DC outputs adapted to portable equipment charging programs. Converter 24 supplies recharge voltages at several outputs connected to connection points 14a, 14b and so on allowing several items of equipment to be recharged simultaneously. Multi-voltage converter 24 can supply recharge voltages comprised for example between 1.2 V and 20 V and DC currents of from 0 to 5 A. These voltage ranges allow simultaneous charging of an earpiece having a 1.2 V and 0.1 A charging program along with a laptop computer with a 19 V and 3 A charging program. The multi-voltage converter 24 is for example of the isolating transformer type using high frequency switching. Voltage regulation is by switching time or width modulation. Several voltage outputs can be obtained via switching regulating circuits of the ion isolated type.

Microprocessor 22 allows the power conversion from multi-voltage converter 24 to be adapted to the specific charging program of each of the items of equipment. Advantageously, the adapter adapts the charging operation to the equipment via a program supplied to the charger. This avoids the need to store charge programs in microprocessor 22 thereby allowing a lower cost and simpler microprocessor with smaller storage capabilities to be used. Further, this avoids being in a situation where the charger does not have a stored charging program suitable for equipment to be recharged. Thus, the charger is always adapted to the equipment to be recharged. The charger is universal. The charger adapts automatically to the portable equipment charge program. This also avoids the need for prior microprocessor programming operations which can be lengthy. Thanks to microprocessor 22, the items of rechargeable equipment can be recharged independently of each other. Various charging programs can be supplied simultaneously to the charger allowing simultaneous recharging of several items of equipment. Prior recognition of the equipment connected can for example be done by sending a low-power alternating signal and reading a response that is characteristic of the equipment (impedance measurement of internal electrical circuit of the equipment, sending of pulses by the equipment, and similar). Equipment recognition allows the microprocessor to determine the charging program for the equipment.

Advantageously, the items of portable equipment each contain their recharging program. The equipment contains its specific charging program stored therein. The equipment is adapted to send its charging program to the charger, and configure the latter. The charger thus adapts to the charging program received by the charger from the portable equipment.

According to an embodiment of charger 10, the latter can detect and visually or aurally signal the passage of current and the correct or incorrect status of the contacts (where the charger and/or equipment contacts are for example too dirty). Detection can for example be done by measuring an abnormal increase in voltage drop between the connection points of charger 10 and those of the rechargeable equipment. Advantageously, such detection is provided for each of connection points 14a, 14b etc of charger 10 so as to be able to individually detect, for each item of equipment, every abnormal situation during charging.

The invention also provides a recharging device comprising charger 10 and a plurality of rechargeable items of portable equipment for different uses, and connected to charger 10. FIG. 2 shows the recharging device comprising charger 10 from FIG. 1.

Charger 10 can be connected via connection 12 and a lead 26 to a vehicle cigarette lighter or to a utility mains supply. Charger 10 can also be connected directly to a utility socket outlet; in this case connection 10 includes a plug that can be plugged into the socket.

Examples of items of rechargeable portable equipment (the list not being limiting) can include PDA's, laptop computers, mobile phones, a mobile phone earpiece, an electronic pen, a wireless transceiver unit, and special projection screen glasses. The latter comprise a plurality of screens opposite the wearer's retina, which replace the screen of a terminal. More generally, the equipment is of the rechargeable battery type.

The items of portable equipment 20a, 20b and so on can be connected to charger 10 via a lead 28. A flexible lead allows the equipment 20a, 20b and so on to continue to be used while being charged. The leads 26 also allow various items of portable equipment to be connected up which do not use the same type of connector.

To connect the leads onto charger 10, the latter advantageously includes RJ 45 type connection points. The use of such connection points ensures compatibility and adaptation to a wide range of equipment as well as to future generation equipment. Thus, the leads 28 can have an RJ 45 type plug at one end which is compatible with the connection point of charger 10 and carrying a plug which is specific to the portable equipment at the other end. Advantageously, the leads have an RJ 45 type plug at each end, charger 10 and the items of portable equipment then having RJ 45 compatible connection points. The advantage here is that one type of lead is sufficient to connect all items of equipment.

It can also be advantageous for at least one lead 28 to be integral with charger 10. The connection point of the charger is now located at the free end of the lead. This avoids the user forgetting or losing the connection lead.

Another embodiment for connecting the portable equipment 20a, 20b, etc to charger 10 consists in ribbons which grip by contact. One connection point 14d of charger 10 is a woven ribbon which co-operates with another different woven ribbon on one of the items of portable equipment 20d. The ribbons grip by contact ensuring mechanical connection between the equipment 20d and connection point 14d. The ribbons can incorporate conducting fibers from the recharging power supply. The conducting fibers are intermingled with conventional plastic fibers, avoiding regions of metalization and flexible blade contacts. Alternatively, the ribbons can be of conducting plastic material. For recharging, charger 10 and equipment 20d each carry two ribbons to close the recharging circuit. The advantage of such connection is that it allows connection without precise alignment between the charger and portable equipment.

Where the connection uses ribbons, there is a risk of reversing contact polarity. To counter polarity reversals, the items of equipment can include a diode bridge preferably with four diodes, the inputs to which are the two regions of electrical contact on the equipment for providing at the output from the bridge, the correct polarity for battery charging.

To improve connection when using ribbons and more generally, to improve connection of metallic regions providing recharging the items of portable equipment can be attached by magnetization to charger 10. A magnet on the charger co-operates with a soft iron pole on the equipment, or vice versa. This provides contact pressure for the metal regions providing recharging. Advantageously, the charger and items of equipment each have a magnet with North-South polarity. Magnet polarity avoids contact polarity reversal. Indeed, magnet polarity guides the user when the portable equipment is being connected to the charger.

Another embodiment of the connection of portable items of equipment 20a, 20b, etc to charger 10 concerns the connection of electronic pen type equipment. This pen is for example fitted with an optical reader allowing, among other things, a text or drawing to be scanned and for the result to be sent by wireless, for example using Bluetooth type transmission. Thus, for recharging a pen type equipment, the charger can include a slot or hole into which the pen is introduced. The connection points of charger 10 are for example flexible conducting blades in the hole or slot, which come into contact with connection points on the pen, for example in the form of a metal band around the pen or metal strips running along the pen.

In one embodiment, charger 10 includes a connection 32 to a computer 30. Computer 30 can adapt the power supply of charger 10 to the portable rechargeable equipment as a function of a charging program downloaded from computer 30. The computer recognizes the item of equipment to be recharged by means such as described above, and can thus supply the charger with a charging program that is specific to the equipment. Advantageously, the charger includes a link between connection 32 and connection points 14a, 14b etc so that an exchange of data can take place between computer 30 connected to connection 32, and one or several items of portable equipment 20a, 20b, etc. This latter configuration is particularly useful when a PDA type item of equipment is connected to the charger. Data updating between the PDA and computer is thus possible. The link between computer 30 and charger 10 is for example of the USB type. The USB type link is adapted to transmit data for adapting and regulating charging, optionally in addition to data updating.

In one embodiment, the computer is adapted to download a charging program from the Internet. The computer is able to automatically look for recharging programs on a Web server. This avoids the need to store recharging programs either on the items of portable equipment or on the charger.

In one embodiment of data updating, charger 10 includes a link between two connection points 14a, 14b etc so that data can be updated between at least two items of equipment 20a, 20b such as a computer and PDA, both in the process of being charged by charger 10.

In one embodiment, recharging device 10 can recharge one or several items of equipment 20e, 20f by connecting them to an item of portable equipment 20c, the latter being itself connected to charger 10. The items of portable equipment 20e, 20f are charged via equipment 20c. This allows the user to use a single charger 10 and prevents him forgetting to recharge one of his items of equipment. This embodiment is advantageous when two items of portable equipment operate together. This is particularly advantageous when the items of portable equipment that are charged via a first item of equipment do not have the connection points suitable for them being charged from the charger.

This embodiment will be described by way of non-limiting example for a PDA and its item of equipment. Among the possible items of equipment 20e, 20f, we find a wireless transceiver 20, adapted to be plugged into PDA 20c for establishing transmission or communications via a mobile telecommunications network. Transceiver unit 20 can have link with a mobile network of any type such as the GPRS (General Packet Radio Service), the GSM (Global System for Mobile Communications) or UMTS (Universal Mobile Telecommunications System) network, etc. Also, an earpiece 20f can be supplied to allow communication via the transceiver unit. Further, a pen can also be provided with the PDA for selecting a command or for data entry on the PDA screen. When the user does not wish to employ an earpiece, which constitutes an item of supplementary portable equipment, the pen can act as an earpiece. In this case, the pen incorporates a microphone and small size loudspeaker.

The items of equipment 20e, 20f of the PDA being able to each incorporate a rechargeable battery, it will be advantageous for these items of equipment to be able to be connected to the PDA and be recharged by the charger 10 at the same time as the PDA. The PDA can then include an electrical link allowing the items of equipment to be connected to charger 10 while the PDA is itself connected to charger 10. The items of equipment are connected to charger 10 via the PDA. This embodiment avoids forgetting to recharge one of the items of equipment. It also makes it possible to recharge the item of equipment using one single charger.

The connection of items of portable equipment 20e, 20f to another item of portable equipment 20c can be done using the same embodiments as those described above in the framework of connecting the items of portable equipment to charger 10. Connection via ribbons or magnets or by introduction into a hole or slot has the advantage of allowing the item of equipment to be fastened onto another item of equipment and be simultaneously charged when the latter is being charged.

Advantageously, charger 10 adapts a receiving portable item of equipment to a source item of portable equipment. This allows the items of portable equipment to as it were “help” each other, via the charger. FIGS. 3-5 show an example of connection between items of portable equipment. This is advantageous for items of equipment that cannot be directly connected to each other.

FIG. 3 shows a charger 10 adapting the interfaces between an item of source equipment 50 and an item of receiving equipment 52. According to one aspect of the mutual “help”, receiving equipment 52 is adapted to recharge on source equipment 50, notably when the charger is not connected to a source of voltage, and equipment 50 is sufficiently charged. This can be advantageous where the equipment to be charged is of small size which doesn't allow it to store much power. According to another aspect, which is alternative to or can be combined with the first aspect, the source equipment 50 can communicate data to receiving equipment 52 while the interfaces are not mutually compatible.

FIG. 3 shows the source equipment 50 and receiving equipment 52 which are respectively connected by a link 54 and a link 56. The connection points 14a, 14b and links can be such that they are as discussed previously. The links can allow recharge current and/or data to flow. The links can be power transmission cords and/or USB links. The double arrows on the links show circulation in both directions. This is particularly advantageous where data transmission in the form of interchange between the items of equipment is involved. The correspondence between the item of equipment 50 and 52 is transmitted via the charger 10, as shown by the double arrow 58. The correspondence travels optionally via microprocessor 22, Further, the items of equipment 50 and 52 and charger 10 (optionally with microprocessor 22) can correspond either pairwise or all together, via wireless transmission of the Bluetooth™ or WiFi™ type. This can be useful when recharging receiving equipment 52, the latter informing source equipment 50 of the charging program to be implemented, or that recharging is over. Also, and in a more general case where an item of equipment is being recharged by the charger, the latter can transmit to the charger, by wireless link, the charging program to be implemented. The items of equipment supply the charger or the other item of equipment with their charging programs by wireless communication.

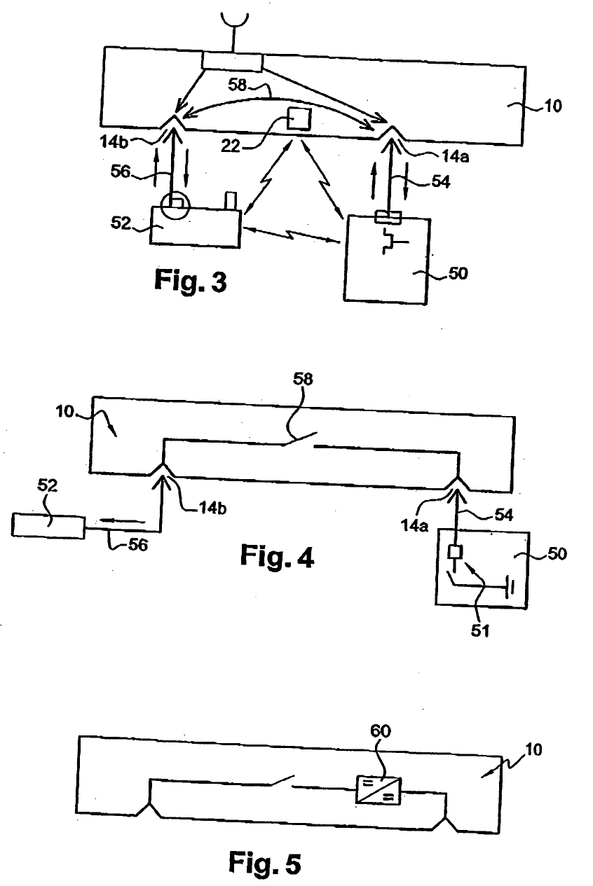

FIG. 4 shows an embodiment of what we have called mutual help. In particular, when mutual help is designed to recharge receiving equipment 50, FIG. 4 shows an embodiment for providing security against accidental discharge of source equipment 50. This can be the case when source equipment 50 is short-circuited for example by a metal key when in the pocket. A software application 51 in equipment 50 triggers a switch function 58 in charger 10 so that the equipment 50 supplies the equipment to be charged 52, passing via charger 10. Equipment 50 only changes over to source mode when connection of the source equipment to charger 10 is detected, enabling receiving equipment 52 to be powered by source equipment 50. This allows equipment 50 to discharge solely to the advantage of charging another item of equipment.

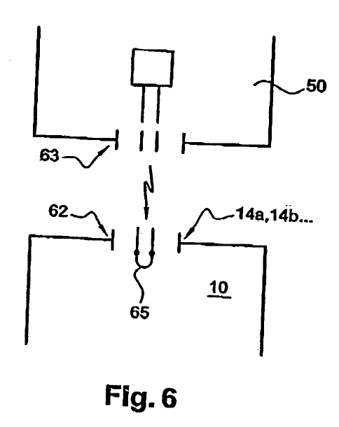

FIG. 5 shows another example of mutual help. After the switch function 58, charger 10 further includes a converter 60, for example a DC-to-DC converter for adapting charging power from equipment 50 to equipment 52.

FIG. 6 shows one example of connection being detected to charger 10 of the item of portable equipment 50 acting as a source, designed to supply power to an item of receiving equipment to be recharged. This detection of connection avoids accidental discharge of the equipment, notably by short-circuiting by for example a key in the pocket. FIG. 6 shows the charger 10 and equipment 50 connected together by one means or another. Charger 10 is connected to one or several connection points 14a, 14b. The connection points include several connection pins 62. The item of equipment also includes several connection pins 63. In the example, there are four pins 60 to 63 to be connected together. Also, pin 63 can be at one end of the lead 28. Charger 10 includes notably two pins 62, and at the center of pins 62 a connecting bridge 65. When an item of equipment is connected to the charger, a circuit is closed by bridge 65 on equipment 50 which becomes alerted to the fact of having been connected to charger 10. This makes it possible to alert the item of source equipment that it is not being short-circuited but is indeed connect to the charger and that it is called upon to deliver recharging power to an item of receiving equipment. The pins 62, 63 at the sides allow transfer of power or otherwise.

Obviously, his invention is not limited to the embodiments described by way of example. Thus, the manner in which the items of portable equipment are fixed to the charger could be arranged independently of the charger described. Similarly, the connection of items of portable equipment to other items of portable equipment in order to recharge them using one single charger could be implemented independently of the charger described.

1-25. (canceled)

26. A recharging device comprising a portable charger, said charger comprising
a connection to a source of electrical power,
a plurality of connection points for items of portable rechargeable equipment for different uses, and
an adapter, being powered by said source of electrical power and adapting it to provide recharging power for the items of portable rechargeable equipment, said adapter comprising
a microprocessor and
a multi-voltage converter supplying voltages and currents adapted to said items of equipment to be recharged, said adapter adapting the charging power to the item of portable equipment as a function of a charging program supplied to said charger, the device further comprising a plurality of items of portable rechargeable equipment for different uses connected to said charger, the charger adapting a receiving item of portable equipment to a source item of portable equipment.

27. The device according to claim 26, wherein the charger is adapted to detect, and signal by a visual or aural signal, an incorrect status of a connection contact.

28. The device according to claim 26, wherein said items of equipment each have their own recharging program.

29. The deice according to claim 26, wherein a first item of equipment is connected to a second item of equipment, the first item of equipment connecting the second item of equipment to the charger.

30. The device according to claim 29, wherein the second item of equipment is charted via the first item of equipment.

31. The device according to claim 26, wherein the device further comprises a computer connected to said charger, said adapter adapting charging power to the item of portable equipment as a function of a charging program supplied by said computer.

32. The device according to claim 31, wherein said computer recognizes the item of portable equipment to be recharged.

33. The device according to claim 32, wherein the computer is adapted to download a charging program from the Internet.

34. The device according to claim 31, wherein the link between the computer and the charger is of the USB type.

35. The device according to claim 26, wherein the item of receiving equipment is adapted to be charged on the item of source portable equipment via said charger (10).

36. The device according to claim 35, wherein said item of source equipment is adapted to trigger a switching function in said charger and to only enable switch-over to generator mode when there is a connection of said item of source equipment to said charger.

37. The device according to claim 35, wherein said charger further comprises a converter adapting the charging power of said item of source equipment to said item of portable receiving equipment.

38. The device according to claim 35, wherein said items of equipment supply said charger or other items of portable equipment with their charging program by wireless link.
